(19) United States
(12) Patent Application Publication
(10) Pub. No.: US 2025/0064233 A1
(43) Pub. Date: Feb. 27, 2025

(54) CONNECTION NAIL OF ARTIFICIAL PLANTS AND PLANT STAND WITH CONNECTION NAIL OF ARTIFICIAL PLANTS

(71) Applicant: HANGZHOU ALLIANCE IMPORT AND EXPORT INC., Hangzhou (CN)

(72) Inventor: Cheng ZHANG, Hangzhou (CN)

(21) Appl. No.: 18/613,227

(22) Filed: Mar. 22, 2024

(30) Foreign Application Priority Data
Aug. 23, 2023 (CN) 202322287218.7

(51) Int. Cl. A47G 7/02; F16B 15/00

(52) U.S. Cl. CPC A47G 7/02; F16B 15/0007

(57) ABSTRACT

A connection nail of artificial plants and a plant stand with connection nail of artificial plants includes a connection base, an installation column and an insertion post, wherein a first end of the installation column is fixedly connected to the connection base, a second end of the installation column is fixedly connected with a connection column, an external diameter of the connection column at a connection end connected to the installation column is greater than an external diameter of the installation column, the external diameter of the connection column is gradually reduced in a direction away from the installation column, a first end of the insertion post is fixed to an end of the connection base away from the installation column, and a second end of the insertion post is provided with a tip part.

### CROSS-REFERENCE TO RELATED APPLICATION

The present application is based on and claims the priority benefits of China application No. 202322287218.7, filed on Aug. 23, 2023. The entirety of China application No. 202322287218.7 is hereby incorporated by reference herein and made a part of this specification.

### TECHNICAL FIELD

The present application relates to the field of fences or indoor/outdoor greening, and in particular, to a connection nail of artificial plants and a plant stand with connection nail of artificial plants.

### BACKGROUND ART

Artificial plants are colorful and durable, which can be used to decorate home, living environments, office environments and other environments through different collocations, which are therefore increasingly and widely applied to hotels, office buildings and other places, and are popular.

At present, in order to achieve beauty and create the effect of feeling in the nature, large areas in some family yards or room partitions or room ceilings, etc. are usually greened. Therefore, the artificial plants on the market are all wound or tied to a frame of a fence or the ceiling. However, in such a way, both the assembly and the later disassembly are difficult.

Therefore, in order to solve the above-mentioned problems, the support rod, which is configured to connect the artificial plants including branches and leaves together, includes outwards convex nails fixed on a fence or frame, and in particular, the bottom end of the support rod is inserted in the nail. However, when a large area must be greened, the nails must be inserted more densely, so that the installation difficulty still exists, the work intensity is higher, the efficiency is lower, and the production cost is higher.

### SUMMARY

In order to facilitate adding artificial plants to a fence or frame and increase the work efficiency, the present application provides a connection nail of artificial plants and a plant stand with connection nail of artificial plants.

The connection nail of artificial plants and the plant stand with connection nail of artificial plants provided in the present application adopt the following technical solutions:

A connection nail of artificial plants includes a connection base, an installation column and an insertion post, a first end of the installation column is fixedly connected to the connection base, a second end of the installation column is fixedly connected with a connection column, an external diameter of the connection column at a connection end connected to the installation column is greater than an external diameter of the installation column, the external diameter of the connection column is gradually reduced in a direction away from the installation column, a first end of the insertion post is fixed to an end of the connection base away from the installation column, and a second end of the insertion post is provided with a tip part.

By adopting the above-mentioned technical solution, the support rods of artificial plants can be inserted in the insertion post firstly, and then the connection column passes through the fence or frame, and in particular, the connection column is located on one side of the fence or frame, while the connection base is located on the other side of the fence or frame, the installation column is connected to the fence or frame, such that the artificial plants can be fixed to the fence or frame, which is convenient to mount and beneficial to increasing the work efficiency.

Optionally, a second end of the connection column away from the installation column is configured with a rounded surface.

By adopting the above-mentioned technical solution, the end of the connection column away from the installation column is designed to be rounded, so that the probability that the working staff is punctured by the connection column in a process that the connection column passes through the fence or frame is reduced.

Optionally, the installation column is provided with at least one bulge loop.

By adopting the above-mentioned technical solution, after the connection column passes through the fence or frame, the fence or frame leans against outer circumference surface of the bulge loop. By means of the bulge loop, the friction force between the installation column and the fence or frame is greatly increased, thereby improving the connection firmness, which reduces the possibility that the installation column falls off from the fence or frame.

Optionally, the connection base, the installation column, the insertion post, the connection column and the at least one bulge loop are injection-molded into an integrated solid structure.

By adopting the above-mentioned technical solution, the connection base, the installation column, the insertion post, the connection column and the at least one bulge loop are injection-molded into an integrated solid structure, which is easily produced while reducing the probability that the connection nail deforms and falls off, and is beneficial to the prolonging of the service life of the connection nail at the same time.

Optionally, the insertion post is in threaded connection to the end of the connection base away from the installation column.

By adopting the above-mentioned technical solution, the insertion post at a position where the artificial plant does not need to be supported can be removed as required, at the same time, the remaining part can still be used for connecting the fence or frame, which reduces the quantity of the used insertion posts and the probability that a user is scratched by the insertion post.

Optionally, the installation column includes a first ringed connection column, a plurality of ringed support columns for bulge loop, a plurality of intermediate ringed support columns, and a second ringed connection column, and in particular, the first ringed connection column, the plurality of ringed support columns for bulge loop, the plurality of intermediate ringed support columns and the second ringed connection column are all shaped like ringed cylinders and are coaxially arranged, the first ringed connection column is fixedly connected to the connection base, the second ringed connection column is fixedly connected to the connection column, the plurality of ringed support columns for bulge loop and the plurality of intermediate ringed support columns are alternately arranged and adjacent to each other, the first ringed connection column and the second ringed connection column are each adjacent to a respective one of the plurality of ringed support columns for bulge loop, the adjacent ones of the above components of the installation column are detachably connected with each other, each of the at least one bulge loop corresponds to a respective one of the plurality of ringed support columns for bulge loop and is mounted on the respective one of the plurality of ringed support columns for bulge loop.

By adopting the above-mentioned technical solution, the installation column is disassembled into a plurality of segments, during the subsequent use, only the broken part instead of the entire connection nail must be replaced, such that the utilization ratio of the product is effectively increased, while prolonging the service life of the entire connection nail.

Optionally, each of the plurality of ringed support columns for bulge loop includes a ringed support column body and a radially movable block, an outer circumference surface of the ringed support column body is coaxially configured with an outer accommodation groove matched with a respective one of the at least one bulge loop, the outer accommodation groove is shaped like a ring groove, an internal diameter of the outer accommodation groove is smaller than an internal diameter of each of the at least one bulge loop, a bottom of the outer accommodation groove is configured with an internal accommodation groove configured to be radially inserted in by the radially movable block, a bottom wall of the internal accommodation groove is configured with a plurality of radial guide holes, the plurality of radial guide holes are distributed in an axial direction of the ringed support column body and extend radially through a side wall of the internal accommodation groove, a radially internal end surface of the radially movable block is provided with a plurality of cylindrical radial guide columns, an axial length of each of the plurality of cylindrical radial guide columns is greater than a depth of each of the plurality of radial guide holes, the connection base is formed with a threaded hole in coaxial communication with an internal cavity of the first ringed connection column, the first end of the insertion post close to the connection base is provided with a screw rod matched with the threaded hole, the first ringed connection column, the plurality of ringed support columns for bulge loop, the plurality of intermediate ringed support columns and the second ringed connection column have a same internal diameter and internal cavities thereof form a central groove shaped like a cylindrical groove, an end of the screw rod away from the insertion post is coaxially provided with a central insertion post, an outer circumference surface of the central insertion post is provided with a plurality of drive rings, the plurality of drive rings are arranged coaxially with each other and are in shape of ringed cylinders, each of the plurality of drive rings corresponds to a respective one of the plurality of ringed support columns for bulge loop, a radially internal end of each of the plurality of cylindrical radial guide columns leans against an outer circumference surface of a respective one of the plurality of drive rings, the radially movable block leans against an internal circumference of a respective one of the at least one bulge loop, and a center rotation axis of the at least one bulge loop is staggered from a center rotation axis of the plurality of ringed support columns for bulge loop.

By adopting the above-mentioned technical solution, the insertion post is in a removed state during mounting. After the remaining part of the connection nail is connected to the fence or frame, the insertion post is inserted and rotates, in this process, the drive rings on the central insertion post drive the radial guide columns at corresponding positions to move radially outwards, the radially movable block synchronously moves radially outwards, to drive the bulge loops to skew to one side, thereby being radially staggered from the ringed support columns for bulge loop. In this way, at the position where the bulge loops are connected to the fence or frame, the connection nail leans against the fence or frame more tightly, thereby increasing the friction force between the both and in turn further improving the connection firmness, which reduces the probability that the installation column falls off from the fence or frame.

Optionally, an outer circumference surface of the at least one bulge loop is provided with a damping layer.

By adopting the above-mentioned technical solution, due to the flexible damping layer, the friction force is further increased, thereby further improving the connection firmness, which reduces the probability that the installation column falls off from the fence or frame.

Optionally, three insertion posts are provided, one first insertion post of the three insertion posts is coaxial with the installation column, and the other two insertion posts of the three insertion posts are symmetrically arranged on two sides of the first insertion post.

By adopting the above-mentioned technical solution, by the three insertion posts, working staff can carry out the insertion of plants according to the density, which improves the diversity in use.

A plant stand connected by the connection nail of artificial plants includes a plurality of first support rods spaced in parallel to each other and a plurality of second support rods spaced in parallel to each other, the plurality of first support rods are located on a same plane, the plurality of second support rods are located on a same plane, the plurality of first support rods and the plurality of second support rods cross each other, each of both the plurality of first support rods and the plurality of second support rods is configured with a plurality of rivet holes, each of the plurality of rivet holes is located in a position where one of the plurality of first support rods overlaps a respective one of the plurality of second support rods, and each of the plurality of first support rods and a respective one of the plurality of second support rods are hinged by the installation column of the connection nail of artificial plants to form a grid-like plant stand.

By adopting the above-mentioned technical solution, the installation column of the connection nail passes through the rivet holes in the positions where the first support rod overlaps with the second support rod, in this way, the first support rods and the second support rods are connected by the connection nails to form a fence. In this way, the use of other connectors can be reduced while fixing the position of the connection nail, thereby achieving the purpose of killing two birds with one stone.

In summary, at least one of the following beneficial effects is realized.
1. The support rods of artificial plants can be inserted in the insertion post firstly, and then the installation column is connected to a fence or frame, such that the artificial plants are fixed to the fence or frame. By the present application it is convenient to mount and beneficial to increasing the work efficiency.
2. By the bulge loop, the friction force between the installation column and the fence or frame is greatly increased, thereby improving the connection firmness, which reduces the possibility that the installation column falls off from the fence or frame.
3. The insertion post on a position where the artificial plant does not need to be supported can be removed as required, at the same time, the remaining part can still be used for connecting the fence or frame, in this way, the used insertion post is reduced, thereby reducing the probability that a user is scratched by the insertion post.
4. By the three insertion posts, working staff can insert plants according to the density, which improves the diversity in use.

### BRIEF DESCRIPTION OF THE DRAWINGS

FIG. 1 is a schematic structural diagram of a connection nail of artificial plants in embodiment 1 of the present application.

FIG. 2 is a schematic structural diagram of a connection nail of artificial plants in embodiment 2 of the present application.

FIG. 3 is a schematic structural diagram of an embodiment of the plant stand in the present application.

FIG. 4 is a sectional diagram of the connection relationship between the connection nail of artificial plants and the plant stand in FIG. 3 in the present application.

FIG. 5 is a schematic structural diagram of another embodiment of the plant stand in the present application.

FIG. 6 is a schematic structural diagram of the section of a connection nail of artificial plants in embodiment 3 of the present application.

FIG. 7 is a schematic structural diagram of the section A-A in FIG. 6 in the present application.

FIG. 8 is a schematic structural diagram of the section B-B in FIG. 6 in the present application.

### DETAILED DESCRIPTION

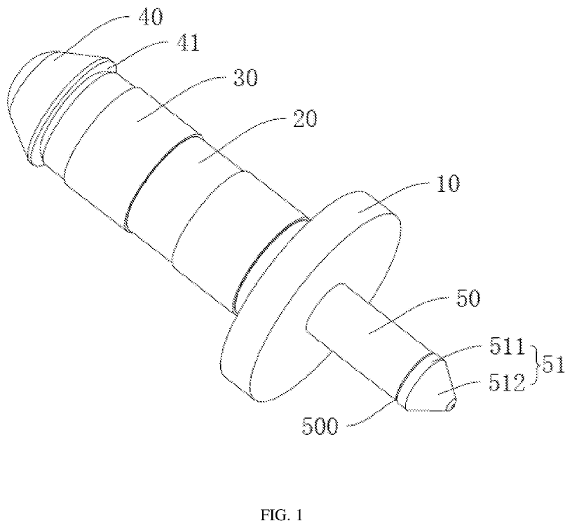

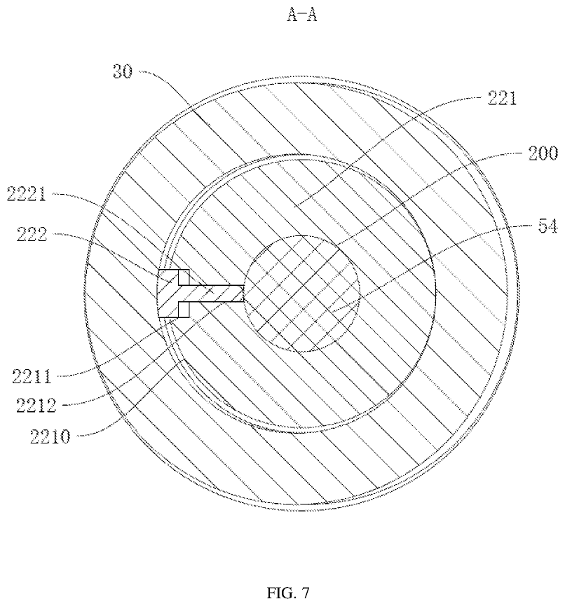

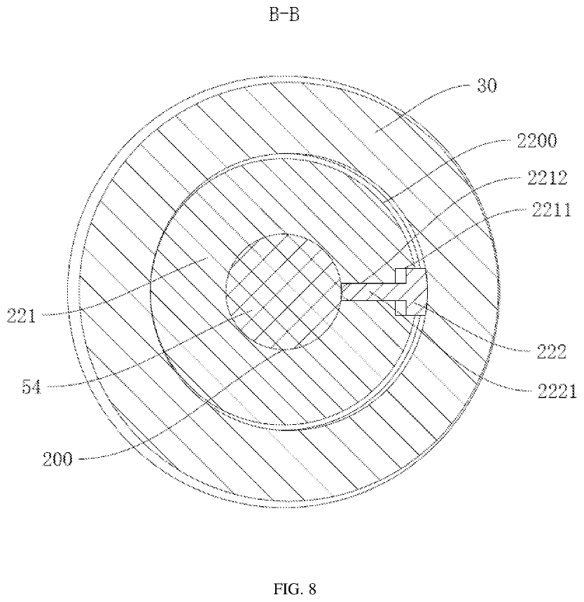

The present application will be further described in detail below in conjunction with FIGS. 1 to 8.

Embodiment 1 discloses a connection nail of artificial plants, with reference to FIG. 1, including a connection base 10, an installation column 20, and an insertion post 50. One end of the installation column 20 is fixedly connected to an end surface of the connection base 10, and an end of the installation column 20 away from the connection base 10 is fixedly connected with a connection column 40. The connection base 10 is shaped like a disc, and the diameter thereof is greater than the external diameter of the installation column 20. The connection column 40, the installation column 20 and the connection base 10 extend coaxially. The external diameter of the connection column 40 is gradually reduced in a direction away from the installation column 20, and the external diameter of the connection end 41 of the connection column 40 connected to the installation column 20 is greater than the external diameter of the installation column 20. The connection column 40 is shaped like a frustum of a cone, such that the connection column 40 can be easily mounted, and the connection nail can be clamped through the connection column 40 when being connected. An end surface of the connection column 40 away from the installation column 20 is formed into a rounded surface, by which the probability that working staff is punctured by the connection column 40 in a mounting process is reduced.

With reference to FIG. 1, two bulge loops 30 are fixedly connected to an outer circumference surface of the installation column 20, the two bulge loops 30 are coaxial with the installation column 20 and are distributed in the axial direction of the installation column 20. By the bulge loops 30, the friction force between the connection column 40 and the fence or frame is increased, thereby reducing the probability that the connection column 40 falls off from the fence or frame.

With reference to FIG. 1, the insertion post 50 is fixedly connected to the end surface of the connection base 10 away from the installation column 20 and is coaxial with the connection base 10. An annular groove 500 is formed in an outer circumference surface of the insertion post 50. A tip part 51 is fixedly connected to an end of the insertion post 50 away from the connection base 10. The tip part 51 includes an insertion head 512 and a limit column 511. The limit column 511 is fixedly connected to an end of the insertion post 50 away from the connection base 10 and is coaxial with the insertion post 50. The diameter of the limit column 511 is greater than the diameter of the insertion post 50. The insertion head 512 is fixedly connected to an end of the limit column 511 away from the insertion post 50 and is coaxial with the limit column 511. The insertion head 512 and the limit column 511 have the same diameter at the connection position, and the diameter of the insertion head 512 is gradually reduced in a direction away from the limit column 511.

In order to facilitate the manufacture, the entire connection nail is injection-molded into an integrated solid structure, which reduces the probability that the connection nail deforms and falls off, and is beneficial to the prolonging of the service life of the connection nail at the same time.

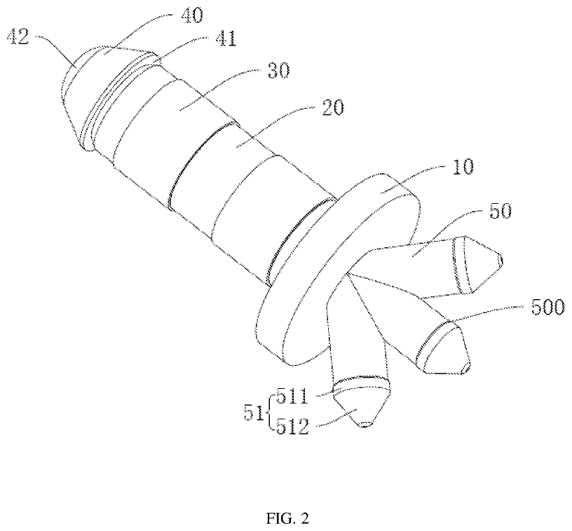

Embodiment 2: with reference to FIG. 2, in order to increase the density of the inserted green plants, three insertion posts 50 are provided, which are all fixedly connected to the end surface of the connection base 10 away from the installation column 20, in particular, one of the insertion posts 50 is coaxial with the installation column 20, the other two of the insertion posts 50 are symmetrically disposed on two sides of the one insertion post 50 coaxial with the installation column 20, and an angle of 45° is formed between the axis of each of the two insertion posts 50 symmetrically disposed and the axis of the installation column 20.

Embodiment 3: this embodiment differs from embodiment 1 in that the insertion post 50 is in threaded connection with an end surface of the connection base 10 away from the installation column 20. The installation column 20 may be disassembled into a plurality of components.

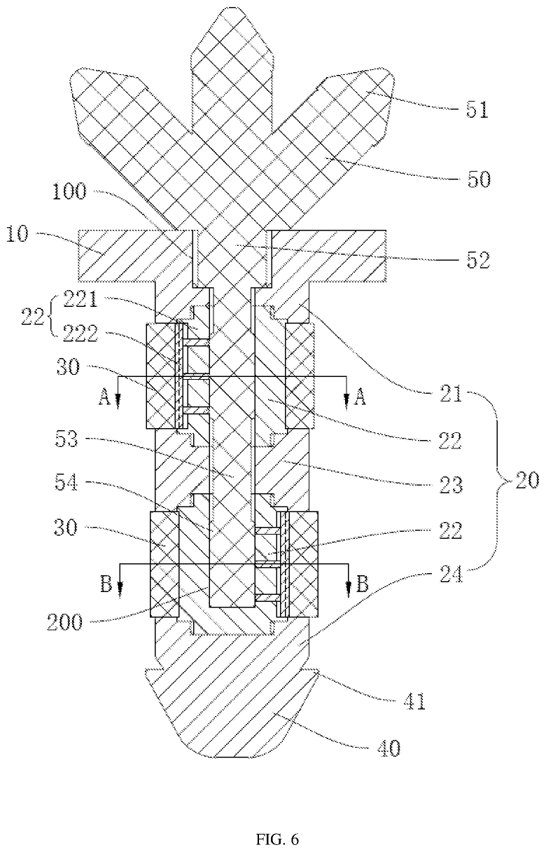

With reference to FIG. 6, the installation column 20 includes a first ringed connection column 21, a pair of ringed support columns for bulge loop 22, an intermediate ringed support column 23, and a second ringed connection column 24, particularly, the first ringed connection column 21, the ringed support columns for bulge loop 22, the intermediate ringed support column 23 and the second ringed connection column 24 are all cylindrical in shape and are coaxial, the first ringed connection column 21, the intermediate ringed support column 23 and the second ringed connection column 24 have the same external diameter greater than the external diameter of the ringed support columns for bulge loop 22, while the first ringed connection column 21, the ringed support columns for bulge loop 22, the intermediate ringed support column 23 and the second ringed connection column 24 have the same internal diameter, and internal cavities thereof form a central groove 200 shaped like a cylindrical groove. The first ringed connection column 21 is fixedly connected to the connection base 10, the second ringed connection column 24 is fixedly connected to the connection column 40. The ringed support columns for bulge loop 22 and the intermediate ringed support columns 23 are alternately arranged and adjacent to each other, and the first ringed connection column 21 and the second ringed connection column 24 are each adjacent to the ringed support column for bulge loop 22. Adjacent components of the installation column 20 are detachably connected with each other. The bulge loops 30 correspond to the ringed support columns for bulge loop 22 one to one and are respectively mounted on the corresponding ringed support column for bulge loop 22.

With reference to FIG. 6, two ends of the ringed support column for bulge loop 22 are respectively configured with an annular connection ring coaxially. The connection rings and the ringed support columns for bulge loop 22 have the same internal diameter, and the outer circumference surfaces of the connection rings are formed with external threads. The end surface of the first ringed connection column 21 away from the connection base 10, two ends of the intermediate ringed support column 23, and the end surface of the second ringed connection column 24 away from the connection column 40 are respectively configured with a threaded hole configured to be matched with the connection ring. Adjacent components of the installation column 20 are in threaded connection with each other.

With reference to FIG. 6 to FIG. 8, the ringed support column for bulge loop 22 includes a ringed support column body 221 shaped like an annular cylinder and a radially movable block 222. The outer circumference surface of the ringed support column body 221 is coaxially configured with an outer accommodation groove 2210 matched with the bulge loop 30, particularly, the internal diameter of the outer accommodation groove 2210 is smaller than the internal diameter of the bulge loop 30. In order to facilitate the assembly of the bulge loop 30 and improve the mounting stability of the bulge loop 30, the internal diameter of the bulge loop 30 is slightly smaller than the external diameter of the ringed support column body 221. The cylindrical bottom of the outer accommodation groove 2210 is formed with an internal accommodation groove 2211 configured to be radially inserted in by the radially movable block 222. The bottom of the internal accommodation groove 2211 is formed with three radial guide holes 2212, which are arranged in the axial direction of the ringed support column body 221 and extend radially through the side wall of the ringed support column body. The radially internal end surface of the radially movable block 222 is configured with three cylindrical radial guide columns 2221, and in particular, the axial length of the radial guide column 2221 is greater than the depth of the radial guide hole 2212.

With reference to FIG. 6, the connection base 10 is configured with a threaded hole 100 in coaxial communication with the internal cavity of the first ringed connection column 21. The end of the insertion post 50 close to the connection base 10 is configured with a screw rod 52 matched with the threaded hole 100. The end of the screw rod 52 away from the insertion post 50 is coaxially configured with a central insertion post 53, and in particular, the diameter of the screw rod 52 is greater than the diameter of the central insertion post 53. The outer circumference surface of the central insertion post 53 is provided with a pair of drive rings 54 in shape of ringed cylinder, which are coaxially arranged, and in particular, the external diameter of the drive ring 54 is greater than the diameter of the central insertion post 53. The drive rings 54 correspond to the ringed support columns for bulge loop 22 one to one, and the radially internal end of the radial guide column 2221 leans against the outer circumference surface of the corresponding drive ring 54. After the assembly is completed, the radially movable block 222 leans against the inner circumference of the corresponding bulge loop 30, and the central rotation axis of the bulge loop 30 is staggered from the central rotation axis of the ringed support column for bulge loop 22d.

In order to improve the smoothness in assembly, with reference to FIG. 6, the end of the radial guide column 2221 away from the radially movable block 222 is formed to be hemispheric, and two ends of the drive rings 54 are respectively rounded.

In order to increase the friction force, with reference to FIG. 6, an included angle between the movement directions of a pair of radially movable blocks 222 is 180°.

In order to increase the friction force, a flexible damping layer is provided on the outer circumference surface of the bulge loop 30, and in particular, the flexible damping layer may be a rubber damping layer.

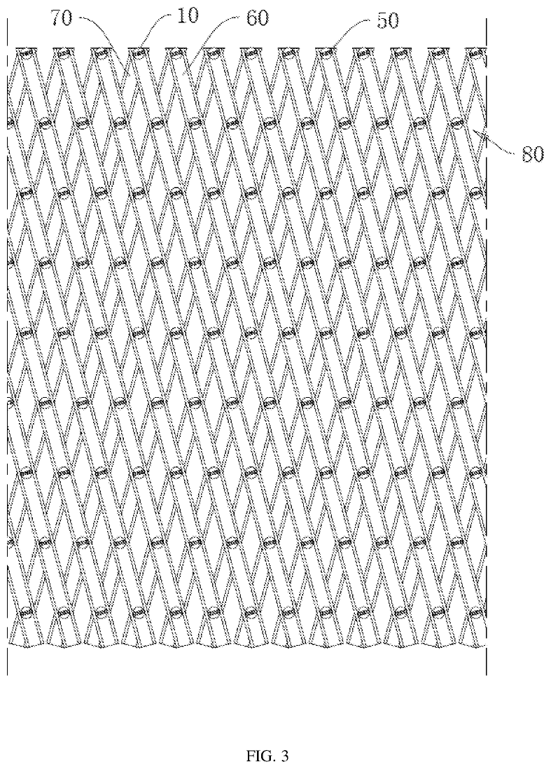

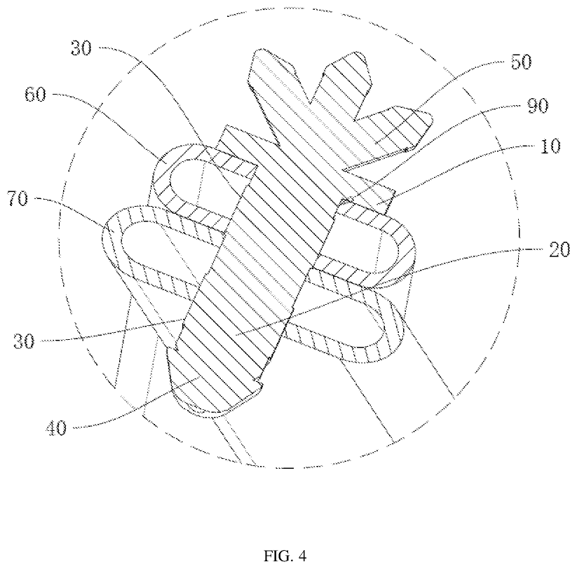

The present application discloses a plant stand with connection nail of artificial plants, with reference to FIG. 3 and FIG. 4, including a plurality of first support rods 60 spaced in parallel to each other and a plurality of second support rods 70 spaced in parallel to each other, and in particular, the first support rod 60 is configured as a hollow rectangular or round or flat tube, and the second support rod 70 is configured as a hollow rectangular or round or flat tube. Spaces 80 are formed between the first support rods 60 and the second support rods 70. Both the first support rods 60 and the second support rods 70 are configured with a plurality of rivet holes 90, which are located in positions where the first support rod 60 overlaps with the second support rod 70, and the first support rods 60 and the second support rods 70 are hinged by the installation columns 20 of the connection nails to form a grid-like plant stand.

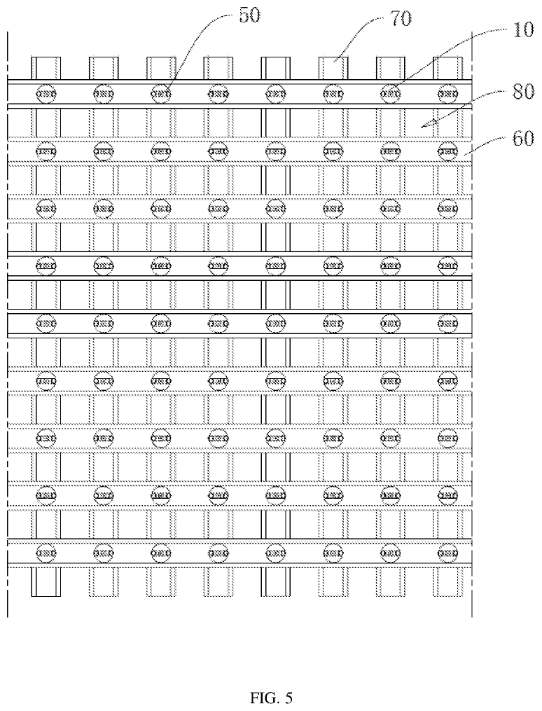

With reference to FIG. 3 and FIG. 5, the spaces 80 are shaped like parallelograms. In addition, the spaces 80 may also be shaped like rectangles.

The connection nail of artificial plants in the present application is implemented in the following way.

Working staff inserts the support rods of artificial plants into the insertion post 50, and during insertion, the operating staff can insert the artificial plants to three insertion posts 50 on the same connection base 10 according to the density requirement.

After insertion of the artificial plants are completed, the connection column 40 passes through the rivet holes 90 in the position where the first support rod 60 overlap with the second support rod 70, so that the first support rod 60 and the second support rod 70 are located between the connection column 40 and the connection base 10, the inner circumference of the rivet hole 90 leans against the outer circumference surface of the bulge loop 30, to complete the insertion of the connection nail, and thus, the artificial plants can be fixed to the first support rods 60 and the second support rods 70. At the same time, the first support rods 60 and the second support rods 70 are hinged by the installation columns 20 of the connection nails of artificial plants to form a grid-like plant stand.

The above descriptions are only preferred embodiments of the present application, and are not intended to limit the protection scope of the present application. Therefore, all equivalent changes made according to the structure, shape and principle of the present application shall fall within the protection scope of the present application.

### LIST OF REFERENCE SIGNS

10 connection base
100 threaded hole
20 installation column
200 central groove
21 first ringed connection column
22 ringed support column for bulge loop
221 ringed support column body
2210 outer accommodation groove
2211 internal accommodation groove
2212 radial guide hole
222 radially movable block
2221 radial guide column
23 intermediate ringed support column
24 second ringed connection column
30 bulge loop
40 connection column
41 connection end
42 rounded surface
50 insertion post
500 groove
51 tip part
511 limit column
512 insertion head
52 screw rod
53 central insertion post
54 drive ring
60 first support rod
70 second support rod
80 space
90 rivet hole

What is claimed is:

1. A connection nail of artificial plants, comprising a connection base, an installation column and an insertion post, wherein a first end of the installation column is fixedly connected to the connection base, a second end of the installation column is fixedly connected with a connection column, an external diameter of the connection column at a connection end connected to the installation column is greater than an external diameter of the installation column, the external diameter of the connection column is gradually reduced in a direction away from the installation column, a first end of the insertion post is fixed to an end of the connection base away from the installation column, and a second end of the insertion post is provided with a tip part.

2. The connection nail of artificial plants according to claim 1, wherein the end of the connection column away from the installation column is configured with a rounded surface.

3. The connection nail of artificial plants according to claim 1, wherein the installation column is provided with at least one bulge loop.

4. The connection nail of artificial plants according to claim 3, wherein the connection base, the installation column, the insertion post, the connection column and the at least one bulge loop are injection-molded into an integrated solid structure.

5. The connection nail of artificial plants according to claim 3, wherein the insertion post is in threaded connection to the end of the connection base away from the installation column.

6. The connection nail of artificial plants according to claim 5, wherein the installation column comprises a first ringed connection column, a plurality of ringed support columns for bulge loop, a plurality of intermediate ringed support columns, and a second ringed connection column, the first ringed connection column, the plurality of ringed support columns for bulge loop, the plurality of intermediate ringed support columns and the second ringed connection column are each shaped like a ringed cylinder and are coaxially arranged, the first ringed connection column is fixedly connected to the connection base, the second ringed connection column is fixedly connected to the connection column, the plurality of ringed support columns for bulge loop and the plurality of intermediate ringed support columns are alternately arranged and adjacent to each other, the first ringed connection column and the second ringed connection column are each adjacent to a respective one of the plurality of ringed support columns for bulge loop, adjacent ones of the first ringed connection column, the plurality of ringed support columns for bulge loop, the plurality of intermediate ringed support columns, and the second ringed connection column of the installation column are detachably connected with each other, each of the at least one bulge loop corresponds to a respective one of the plurality of ringed support columns for bulge loop and is mounted on the respective one of the plurality of ringed support columns for bulge loop.

7. The connection nail of artificial plants according to claim 6, wherein each of the plurality of ringed support columns for bulge loop comprises a ringed support column body and a radially movable block, an outer circumference surface of the ringed support column body is coaxially configured with an outer accommodation groove matched with a respective one of the at least one bulge loop, the outer accommodation groove is shaped like a ring groove, an internal diameter of the outer accommodation groove is smaller than an internal diameter of each of the at least one bulge loop, a bottom of the outer accommodation groove is configured with an internal accommodation groove configured to be radially inserted in by the radially movable block, a bottom wall of the internal accommodation groove is configured with a plurality of radial guide holes, the plurality of radial guide holes are distributed in an axial direction of the ringed support column body and extend radially through a side wall of the internal accommodation groove, a radially internal end surface of the radially movable block is provided with a plurality of cylindrical radial guide columns, an axial length of each of the plurality of cylindrical radial guide columns is greater than a depth of each of the plurality of radial guide holes, the connection base is formed with a threaded hole in coaxial communication with an internal cavity of the first ringed connection column, the first end of the insertion post is provided with a screw rod matched with the threaded hole, the first ringed connection column, the plurality of ringed support columns for bulge loop, the plurality of intermediate ringed support columns and the second ringed connection column have a same internal diameter, the internal cavity of the first ringed connection column and internal cavities of the plurality of ringed support columns for bulge loop, the plurality of intermediate ringed support columns and the second ringed connection column form a central groove shaped like a cylindrical groove, an end of the screw rod away from the insertion post is coaxially provided with a central insertion post, an outer circumference surface of the central insertion post is provided with a plurality of drive rings, the plurality of drive rings are arranged coaxially with each other and are in a shape of ringed cylinders, each of the plurality of drive rings corresponds to a respective one of the plurality of ringed support columns for bulge loop, a radially internal end of each of the plurality of cylindrical radial guide columns leans against an outer circumference surface of a respective one of the plurality of drive rings, and the radially movable block leans against an internal circumference of a respective one of the at least one bulge loop, such that a center rotation axis of the at least one bulge loop is staggered from a center rotation axis of the plurality of ringed support columns for bulge loop.

8. The connection nail of artificial plants according to claim 3, wherein an outer circumference surface of the at least one bulge loop is provided with a damping layer.

9. The connection nail of artificial plants according to claim 1, wherein three insertion posts are provided, a first insertion post of the three insertion posts is coaxial with the installation column, and another two insertion posts of the three insertion posts are symmetrically arranged on two sides of the first insertion post.

10. A plant stand connected by the connection nail of artificial plants according to claim 1, comprising a plurality of first support rods spaced in parallel to each other and a plurality of second support rods spaced in parallel to each other, wherein the plurality of first support rods are located on a same plane, the plurality of second support rods are located on a same second plane, the plurality of first support rods and the plurality of second support rods cross each other, each of the plurality of first support rods and the plurality of second support rods is configured with a plurality of rivet holes, each of the plurality of rivet holes is located in a position where one of the plurality of first support rods overlaps a respective one of the plurality of second support rods, and each of the plurality of first support rods and one of the plurality of second support rods are hinged by the installation column of the connection nail of artificial plants to form a grid-like plant stand.
